(19) United States
(12) Patent Application Publication
(10) Pub. No.: US 2020/0019547 A1
(43) Pub. Date: Jan. 16, 2020

(54) APPARATUS AND METHOD FOR DISPLAYING SEARCH RESULTS USING COGNITIVE PATTERN RECOGNITION IN LOCATING DOCUMENTS AND INFORMATION WITHIN

(71) Applicant: ImageScan, Inc., Pasadena, CA (US)

(72) Inventors: Basker S. Krishnan, San Marino, CA (US); Hanoz J. Kateli, Monrovia, CA (US); Bryan Heesch, Pasadena, CA (US)

(73) Assignee: ImageScan, Inc., Pasadena, CA (US)

(21) Appl. No.: 16/581,043

(22) Filed: Sep. 24, 2019

Related U.S. Application Data
(63) Continuation-in-part of application No. 13/280,281, filed on Oct. 24, 2011, now Pat. No. 10,467,273.

(51) Int. Cl. G06F 16/248; G06F 16/93

(52) U.S. Cl. CPC G06F 16/248; G06F 16/93

(57) ABSTRACT

An apparatus and method for searching and displaying including inputting at least one search text; searching a database to generate a search result with at least one document, wherein each of the at least one document includes one or more of the at least one search text; displaying the search result wherein each of the at least one document is shown in a three-dimensional (3D) display with one or more pages in a scaled common image format (CIF), wherein at least one of the one or more pages includes one or more of the at least one search text.

### CLAIM OF PRIORITY

This application is a continuation-in-part application of patent application Ser. No. 13/280,281 filed Oct. 24, 2011, the entire contents of the prior application are incorporated herein by reference as if fully set forth below in its entirety and for all applicable purposes.

### TECHNICAL FIELD

This disclosure relates generally to apparatus and methods for visual presentation of search results. More particularly, the disclosure relates to visually presenting search results to enable use of cognitive pattern recognition.

### BACKGROUND

In current document files, it is known that many documents with similar or even identical words exist. Thus, with the commonality of words and phrases in different documents or even different versions of the documents, it is time consuming to find an exact document quickly and efficiently. Often, a keyword search could produce a list of many documents with the same word and even include all the various versions of the different documents containing the keyword. This is especially problematic if the keyword used in the search is a common word for a particular application.

### SUMMARY

Disclosed is an apparatus and method for searching and displaying results using cognitive pattern recognition. According to one aspect, an apparatus and method for searching and displaying using cognitive pattern recognition including searching at least one document for at least one search text, wherein the at least one search text is associated with a highlight option; selecting to enable or to disable the highlight option; presenting a quantity of the at least one document in a scaled common image format (CIF); and displaying a selected amount of pages in the scaled common image format (CIF), wherein the at least one search text is shown according to whether the highlight option is enabled or disabled.

According to another aspect, a method for searching and displaying using cognitive pattern recognition including searching at least one document for at least one search text, wherein the at least one search text is associated with a highlight option; selecting to enable or to disable the highlight option; and displaying a selected amount of pages in the scaled common image format (CIF), wherein the at least one search text is shown according to whether the highlight option is enabled or disabled.

According to another aspect, an apparatus for searching and displaying using cognitive pattern recognition, the apparatus comprising a processor and a memory, the memory containing program code executable by the processor for performing the following: searching at least one document for at least one search text, wherein the at least one search text is associated with a highlight option; selecting to enable or to disable the highlight option; presenting a quantity of the at least one document in a scaled common image format (CIF); and displaying a selected amount of pages in the scaled common image format (CIF), wherein the at least one search text is shown according to whether the highlight option is enabled or disabled.

According to another aspect, an apparatus for searching and displaying using cognitive pattern recognition, the apparatus comprising a processor and a memory, the memory containing program code executable by the processor for performing the following: searching at least one document for at least one search text, wherein the at least one search text is associated with a highlight option; selecting to enable or to disable the highlight option; and displaying a selected amount of pages in the scaled common image format (CIF), wherein the at least one search text is shown according to whether the highlight option is enabled or disabled.

According to another aspect, a method for searching and displaying including inputting at least one search text; searching a database to generate a search result with at least one document, wherein each of the at least one document includes one or more of the at least one search text; displaying the search result wherein each of the at least one document is shown in a three-dimensional (3D) display with one or more pages in a scaled common image format (CIF), wherein at least one of the one or more pages includes one or more of the at least one search text.

In one example, a first page of each of the at least one document is shown in the three-dimensional (3D) display. In one example, the first page includes one of the at least one search text. In one example, a search text indicator is included to one of the at least one document. In one example, each of the one or more pages includes one or more of the at least one search text. In one example, the one or more pages of one of the at least one document includes at least one active link pointer.

In one example, the method further includes displaying a single page associated with one of the at least one active link pointer on a single page display. In one example, the single page display is adjacent to the three-dimensional (3D) display. In one example, the single page display and the three-dimensional (3D) display are adjacent to each other on a single screen. In one example, the single page display and the three-dimensional (3D) display are displayed on different screens.

In one example, the method further includes displaying one or more of the at least one document with its corresponding relative document length. In one example, the method further includes displaying the relative document length as a three-dimensional display. In one example, the method further includes displaying the one or more pages of one of the at least one document with one or more indication of page location relative to the relative document length.

According to another aspect, an apparatus for searching and displaying, the apparatus including a processor and a memory, the memory containing program code executable by the processor for performing the following: inputting at least one search text; searching a database to generate a search result with at least one document, wherein each of the at least one document includes one or more of the at least one search text; displaying the search result wherein each of the at least one document is shown in a three-dimensional (3D) display with one or more pages in a scaled common image format (CIF), wherein at least one of the one or more pages includes one or more of the at least one search text.

In one example, a first page of each of the at least one document is shown in the three-dimensional (3D) display. In one example, the first page includes one of the at least one search text. In one example, the memory further includes program code for including a search text indicator to one of the at least one document. In one example, each of the one or more pages includes one or more of the at least one search text.

In one example, the one or more pages of one of the at least one document includes at least one active link pointer. In one example, the memory further includes program code for displaying a single page associated with one of the at least one active link pointer on a single page display. In one example, the single page display is adjacent to the three-dimensional (3D) display. In one example, the single page display and the three-dimensional (3D) display are adjacent to each other on a single screen.

In one example, the single page display and the three-dimensional (3D) display are displayed on different screens. In one example, the memory further includes program code for displaying one or more of the at least one document with its corresponding relative document length. In one example, the memory further includes program code for displaying the relative document length as a three-dimensional display. In one example, the memory further includes program code for displaying the one or more pages of one of the at least one document with one or more indication of page location relative to the relative document length.

Advantages of the present disclosure may include reducing the steps and time needed to search for an object (e.g., a document) or information within the object. Another advantage may include increased accuracy and built in fault tolerance, for example, for OCR (optical character recognition) errors and misfiles in locating an object or information within the object. Yet, another advantage may include increase efficiency in searching and identifying a relevant document. One skilled in the art would understand that the listed advantages are not exclusive and there is no requirement that one or more of the listed advantages apply to a particular claimed method or apparatus.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a flow diagram 100 for searching and displaying results using cognitive pattern recognition.

FIG. 2 illustrates an example of pages of at least one or more document where the search text exists wherein a highlight option is disabled.

FIG. 3 illustrates an example of pages of at least one or more document where the search text exists wherein a highlight option is enabled.

FIG. 4 illustrates the example of FIG. 2 where some of the pages are presented with a visual distinction (i.e., in a different format) than the rest of the pages.

FIG. 5 illustrates the example of FIG. 3 where some of the pages are presented with a visual distinction (i.e., in a different format) than the rest of the pages.

FIG. 6 illustrates an example of a device comprising a processor in communication with a memory for executing the algorithm in the flow diagram illustrated in FIG. 1.

FIG. 7 illustrates an example of a device suitable for searching and displaying results using cognitive pattern recognition in the flow diagram illustrated in FIG. 1.

FIG. 8 illustrates a first example of a set of documents displayed from a search result.

FIG. 9 illustrates a second example of a set of documents displayed from a search result.

FIG. 10 illustrates a third example of a set of documents displayed from a search result.

FIG. 11 illustrates a fourth example of a set of documents displayed from a search result.

FIG. 12A illustrates a first example of a three-dimensional (3D) display of a set of documents from a search result.

FIG. 12B illustrates the three-dimensional (3D) display of the search result shown in FIG. 12A with a single page display on a screen.

FIG. 13 illustrates a second example of a three-dimensional (3D) display of a set of documents from a search result.

FIG. 14 illustrates three examples of indicating whether a first page of a document includes a search text.

FIG. 15 illustrates an example of a three-dimensional (3D) display of a set of documents from a search result with indications of relative document length.

FIG. 16 illustrates an example of a three-dimensional (3D) display of a set of documents from a search result with indications of page location relative document length.

FIG. 17 illustrates an example of the three-dimensional (3D) display of the search result shown in FIG. 12A without the indication of individual pages.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

A search may be based on not just words contained in a document, but also the user's memory of a visual image of the document and/or the approximate date of the document. For example, different documents or versions of a same document may contain many identical keywords. However, the visual presentation (i.e., display) of the first page (or any other page) of different documents or types of documents may differ. Thus, there's a need for a search & display approach that can utilize the aspects of keyword searching and visual presentation (i.e., display) of the document being searched to quickly and efficiently locate the document in a document repository (e.g., database.). For example, the human brain can quickly identify the visual pattern of a needed document(s) using cognitive pattern recognition (CPR), and distinguish between like document patterns using meta data tags displayed alongside the document display in scaled common image format (CIF). One skilled in the art would understand that a document repository may include an electronic repository or an electronic database.

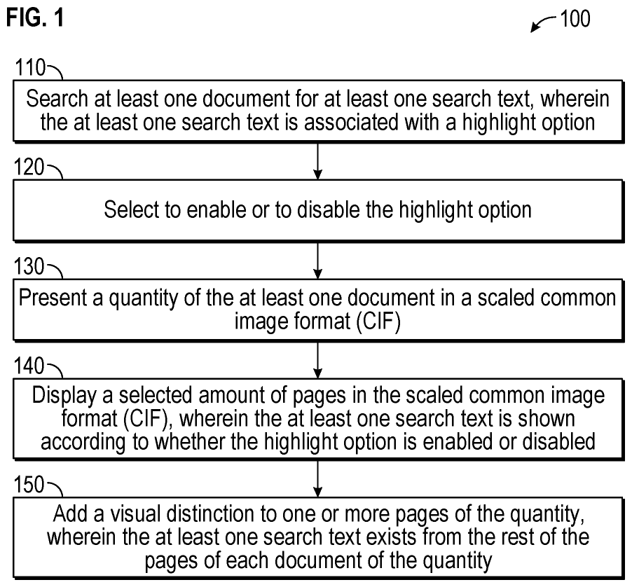

FIG. 1 illustrates an example of a flow diagram 100 for searching and displaying results using cognitive pattern recognition. In block 110, search at least one document for at least one search text, wherein the at least one search text is associated with a highlight option. In one example, the highlight option allows a user to determine which search text should be differentiated from the remaining text of a document when the search text found within the document. The differentiation allows a user to quickly distinguish the search text from the rest of the remaining text. In one example, the search text with the highlight option enabled is differentiated from the remaining text of the document in one or more of the following manner: highlighted by a different color (i.e., color differentiation), bolded, italicized, underlined, etc. One skilled in the art would understand that the list of ways to “differentiate” a text from the remaining text as presented herein is not an exclusive list and that other manners of differentiating a search text may be part of the highlight option without affecting the scope and/or spirit of the present disclosure.

In one example, the highlight option includes a color differentiation (e.g., a yellow color) added to a search text. In another example, the highlight option includes varying the fonts, the mark-ups, or an added visual distinction to the search text. In yet another example, the highlight option includes adding a border around the search text. One skilled in the art would understand that the examples listed of the highlight option are not limiting and that other examples of differentiating a search text from the rest of the text on a page of a document are within the spirit and scope of the present disclosure.

In one aspect, different search text may be associated with different highlight options. For example, a first search text may be highlighted in yellow while a second search text may be bolded. One skilled in the art would understand that multiple search text may be associated with different highlight options, that is, with different examples of distinguishing the multiple search text from each.

A “search text” as used in the present disclosure may be a single word, a collection of words (i.e., a phrase of contiguous words), a symbol, a regular expression, a number, a special character and/or any combination thereof. In one aspect, the at least one search text comprises multiple search text to be searched concurrently with one or more documents. In one example, a search text is a keyword, a date or date range, a meta data, etc. In one example, multiple search text may be used in a search.

In one aspect, the at least one document is searched based on one or more of the following: an attribute, an attribute range or a special definition. For example, an attribute may be a significant identifier such as a social security number (SSN) and the search might involve a single, multiple (within a range) or all SSNs within documents in a repository. For example, an attribute may be a special symbol or a special character. For example, an attribute range may be all dates within a specified range (e.g., from Jan. 1, 2000-Dec. 30, 2010). For example, an attribute range may be all amounts found within a range (e.g., $50,000 to $100,000 or 1 liter to 1000 liters, etc.) within documents. In one aspect, the special definition may be a list of predefined synonyms. In another aspect, the special definition may be a list of antonyms.

Following block 110, in block 120, select to enable or to disable the highlight option. In one example, the highlight option associated with one search text is enabled, such that, for example, the search text would be highlighted in yellow each time it occurs on a page of a document of a repository or database. In one example, the repository is the Internet. In another example, the repository is a private database. In one example with multiple search text, each of the search text is associated with a highlight option which may be enabled or disabled. And, in another example, multiple search text with their highlight option enabled may be differentiated from each other. For example, a first search text with its highlight option enabled may be bolded, a second search text with its highlight option enabled may be underlined, a third search text with its highlight option enabled may be italicized. And, another search text may have its highlight option disabled such that it is not differentiated from the remaining text (non-searched text) of the document.

In block 130, present a quantity of the at least one document in a scaled common image format (CIF). One skilled in the art would understand that presenting a quantity of the at least one document (as defined in block 130) may include presenting one or more documents.

In one aspect, common image format (CIF) is a digital representation of a document which retains the look and feel of the document in a printed form or it is a visual representation of the pages within digitally converted paper or electronically created documents. In one example, the first page of each of the quantity of the searched documents is presented in the scaled common image format (CIF). In one example, a first page of each of the quantity of the searched documents is presented in the scaled common image format (CIF). In one example, the presenting of the quantity is done in a predetermined order. And, in one example, the predetermined order is based on a meta data parameter. In one aspect, at least one meta data parameter is presented along with the scaled common image format (CIF). In another aspect, a portion of a meta data parameter is presented along with the scaled common image format (CIF). In one example, the meta data parameter is modified before being presented. In one aspect, the at least one meta data parameter is a date information. The date information, for example, may be a date the document is created, a date contained within the document, a date the document is processed, such as scanned, or a date assigned to the document, etc.

Following block 130, in block 140, display a selected amount of pages in the scaled common image format (CIF), wherein the at least one search text is shown according to whether the highlight option is enabled or disabled. In one example, the selected amount is the pages wherein the at least one search text exists on each of the pages and wherein the search text is presented with the highlight option enabled. In one example, the selected amount is a chosen quantity of pages, and may range, for example, from a single page to multiple pages. In one example, the selected amount of pages is from a single document.

Following block 140, in block 150, add a visual distinction to one or more pages of the quantity where the at least one search text exists from the rest of the pages of each document of the quantity. In one example, the selected amount includes all the pages with the added visual distinction. In one example, the selected amount is from a single document.

One skilled in the art would understand that although the steps in blocks 110 through 150 are written in a particular order (the step in block 150 follows the step in block 140 which follows the step in block 130 which follows the step in block 120 which follows the step in block 110), the order of the steps may be interchanged without affecting the scope or spirit of the present disclosure. In one aspect, some of the steps in FIG. 1 are performed by a computer, such as a personal computer. In another aspect, some of the steps in FIG. 1 are performed by a handheld device that incorporates at least one processor.

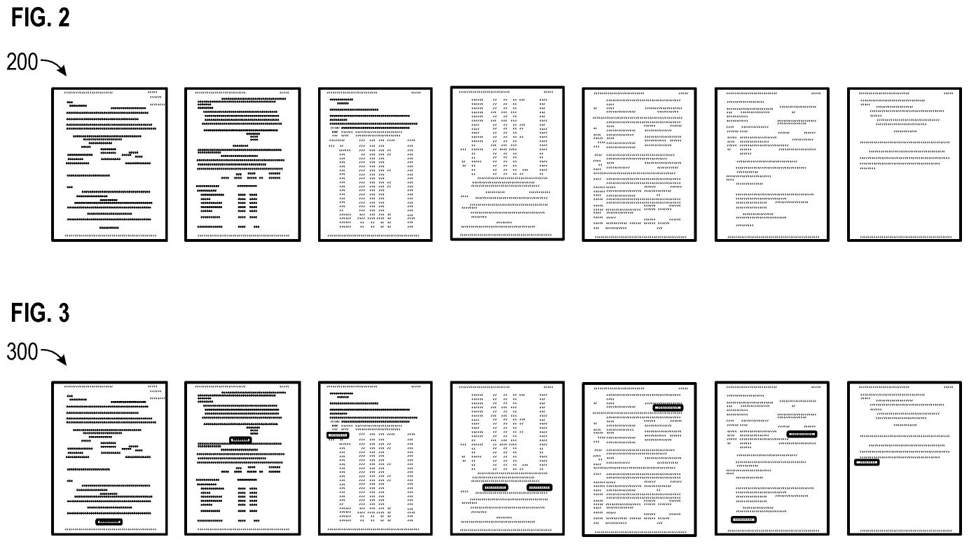

FIG. 2 illustrates an example 200 of pages of at least one or more document where the search text exists wherein a highlight option is disabled. FIG. 2 illustrates an example of pages of at least one or more document where the search text exists, but in the example of FIG. 2, the highlight option of the search text is disabled.

FIG. 3 illustrates an example 300 of pages of at least one or more document where the search text exists wherein a highlight option is enabled. FIG. 3 illustrates an example of pages of at least one or more document where the search text exists, but in the example of FIG. 3, the highlight option of the search text is enabled.

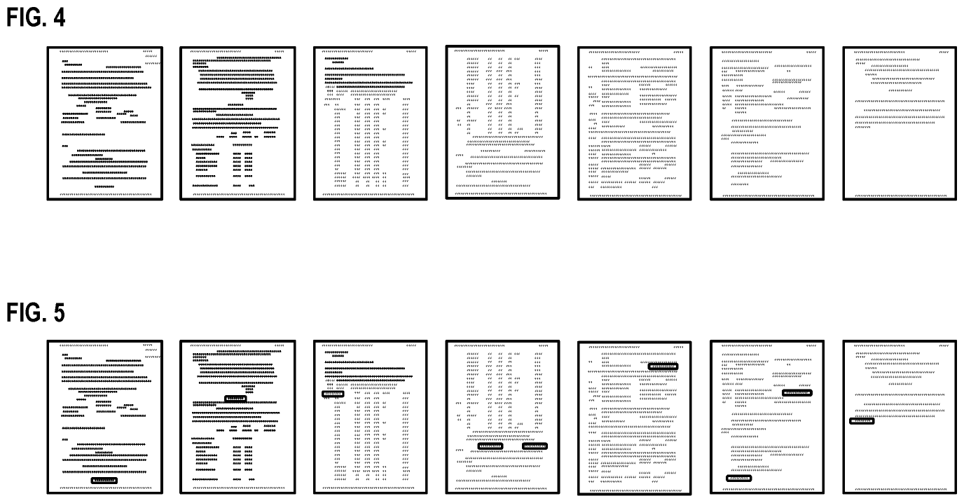

FIG. 4 illustrates the example of FIG. 2 where some of the pages are presented with a visual distinction (i.e., in a different format) than the rest of the pages. As illustrated in FIG. 4, the second and third pages are presented with borders. In one aspect, a user determines whether some of the pages are to be presented in the different format. Furthermore, the user may determine what the different format should be, for example, in using borders or some other different formatting. And, the user may determine the one or more criteria for some of the pages to be presented in the different format. One skilled in the art would understand that other forms of different formats, not limited to borders as illustrated herein, may be used without restricting the scope and spirit of the present disclosure.

FIG. 5 illustrates the example of FIG. 3 where some of the pages are presented with a visual distinction (i.e., in a different format) than the rest of the pages. As illustrated in FIG. 5, the second and third pages are presented with borders where the highlight search text is found. In one aspect, a user determines whether some of the pages are to be presented in the different format. Furthermore, the user may determine what the different format should be, for example, in using borders or some other different formatting. And, the user may determine the one or more criteria for some of the pages to be presented in the different format. One skilled in the art would understand that other forms of different formats, not limited to borders as illustrated herein, may be used without restricting the scope and spirit of the present disclosure.

In one aspect, cognitive pattern recognition is based on prior cognitive knowledge. For example, recognition is based on a collective memory about the document being searched. The cognition pattern being recognized may be based on memory of one or more of the following: file format (e.g., Word, Excel etc.), approximate date of the document (last month, last quarter, last year etc.), from and to details on correspondence/email/fax, keywords within documents, key sections within documents (e.g., pricing details within a proposal or termination clause within a contract); memory of how various digital file formats look.

In another example, recognition is based on cognitive intelligence. For example, the search is for a document that one is not familiar with, however aspects of the document are known to the searcher. In one example, the search is for a tax form, a court document or a lab report, etc, wherein each has its unique image pattern that is easily recognizable. In another example, the location of the search text (e.g., highlighted keyword(s)) within a page in common image format allows cognitive pattern recognition. Based on common image format (e.g., miniature visual display) of documents containing highlighted keyword(s), one can quickly recognize and comprehend the relevance of various documents like Correspondence, Presentations, Proposals Cost Estimates for Cleanup etc. as events on a time line or as a relevant document pertaining to an issue.

One skilled in the art would understand that the steps disclosed in the example flow diagram in FIG. 1 may be interchanged in their order without departing from the scope and spirit of the present disclosure. Also, one skilled in the art would understand that the steps illustrated in the flow diagrams are not exclusive and other steps may be included or one or more of the steps in the example flow diagrams may be deleted without affecting the scope and spirit of the present disclosure.

Those of skill would further appreciate that the various illustrative components, logical blocks, modules, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise memory stick, RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

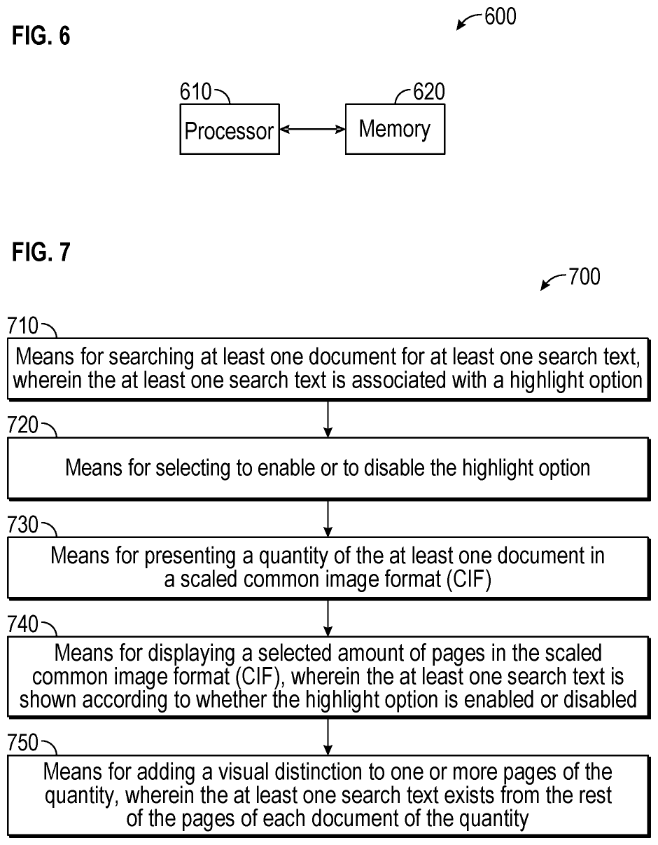

In one example, the illustrative components, flow diagrams, logical blocks, modules and/or algorithm steps described herein are implemented or performed with one or more processors. In one aspect, a processor is coupled with a memory which stores data, meta data, program instructions, etc. to be executed by the processor for implementing or performing the various flow diagrams, logical blocks and/or modules described herein. FIG. 6 illustrates an example of a device 600 comprising a processor 610 in communication with a memory 620 for executing the algorithm in the flow diagram illustrated in FIG. 1. In one aspect, the memory 620 is located within the processor 610. In another aspect, the memory 620 is external to the processor 610. In one aspect, the processor includes circuitry for implementing or performing the various flow diagrams, logical blocks and/or modules described herein.

FIG. 7 illustrates an example of a device 700 suitable for searching and displaying results using cognitive pattern recognition in the flow diagram illustrated in FIG. 1. In one aspect, the device 700 is implemented by at least one processor comprising one or more modules configured to search using cognitive pattern recognition as described herein in blocks 710, 720, 730, 740 and 750. For example, each module comprises hardware, firmware, software, or any combination thereof. In one aspect, the device 700 is also implemented by at least one memory in communication with the at least one processor.

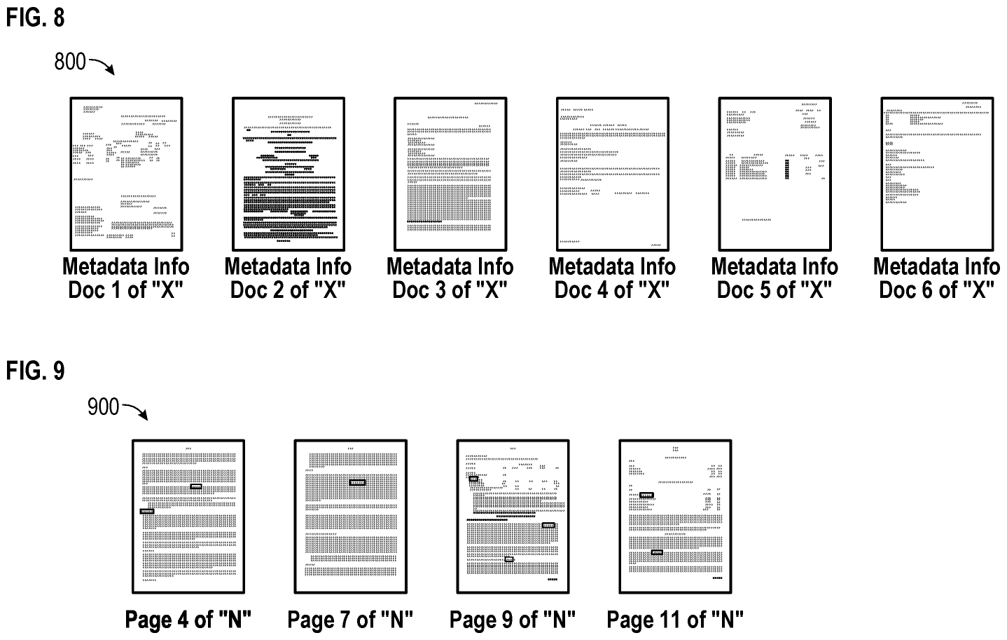

FIG. 8 illustrates a first example 800 of a set of documents displayed from a search result. In this first example, illustrated in FIG. 8, the set of documents are displayed in a scaled common image format (CIF) with meta data information in the image tag.

FIG. 9 illustrates a second example 900 of a set of documents displayed from a search result. In this second example, the set of documents may be displayed in a scaled CIF with meta data information in the image tag. For example, in FIG. 9, only the pages with the search text (e.g., keyword(s)) that are marked are displayed.

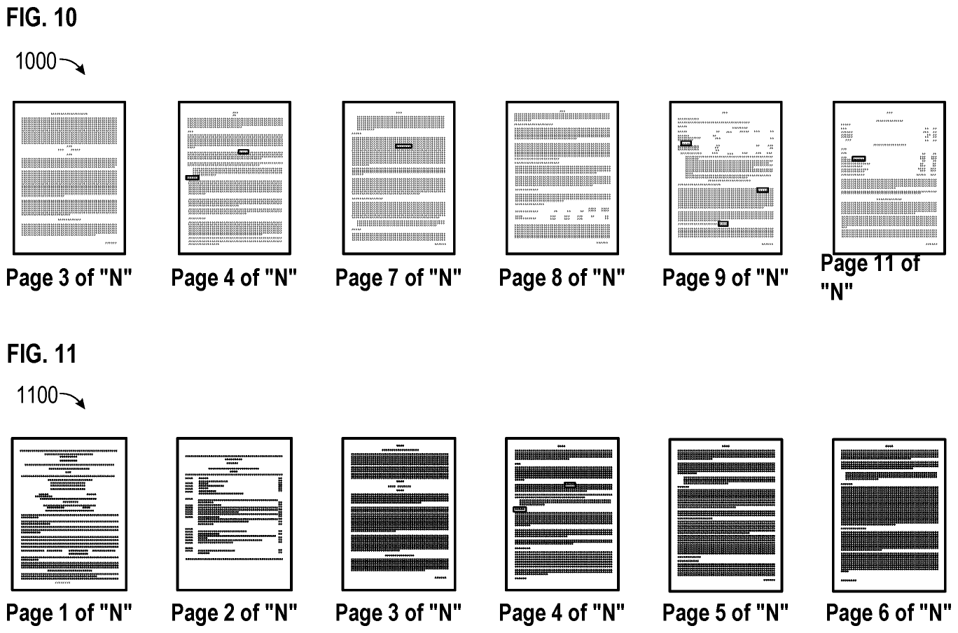

FIG. 10 illustrates a third example 1000 of a set of documents displayed from a search result. In this third example, the set of documents may be displayed in a scaled CIF with meta data information in the image tag. For example, in FIG. 10, the pages with all the search text (e.g., keyword(s)) found are displayed. In one example, the display includes pages with the search text the highlight option enabled as well as the search text with the highlight option disabled. In one example, the search text with the highlight option enabled is displayed differently than the search text with the highlight option disabled.

FIG. 11 illustrates a fourth example 1100 of a set of documents displayed from a search result. In this fourth example, the set of documents may be displayed in a scaled CIF with meta data information in the image tag. For example, as illustrated in FIG. 11, all the pages within a document are displayed. This includes pages with the search text the highlight option enabled as well as the search text with the highlight option disabled. In one example, the search text with the highlight option enabled is displayed differently than the search text with the highlight option disabled.

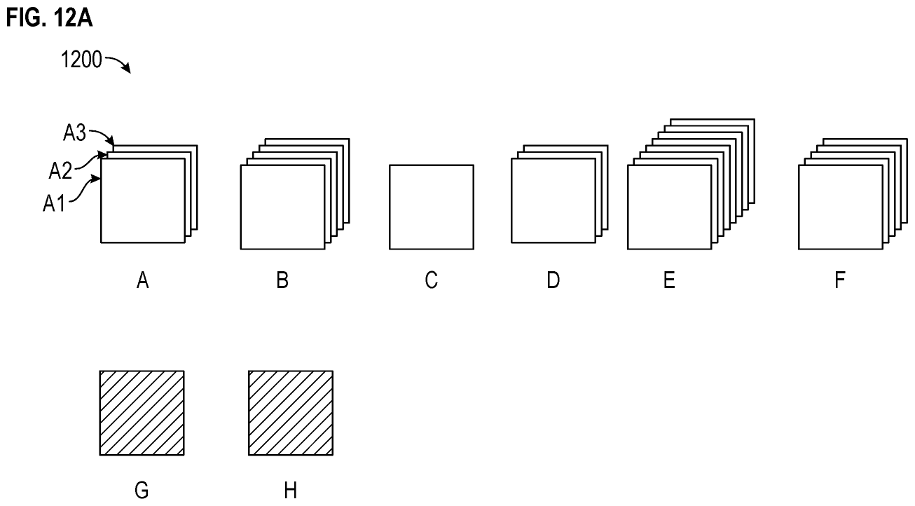

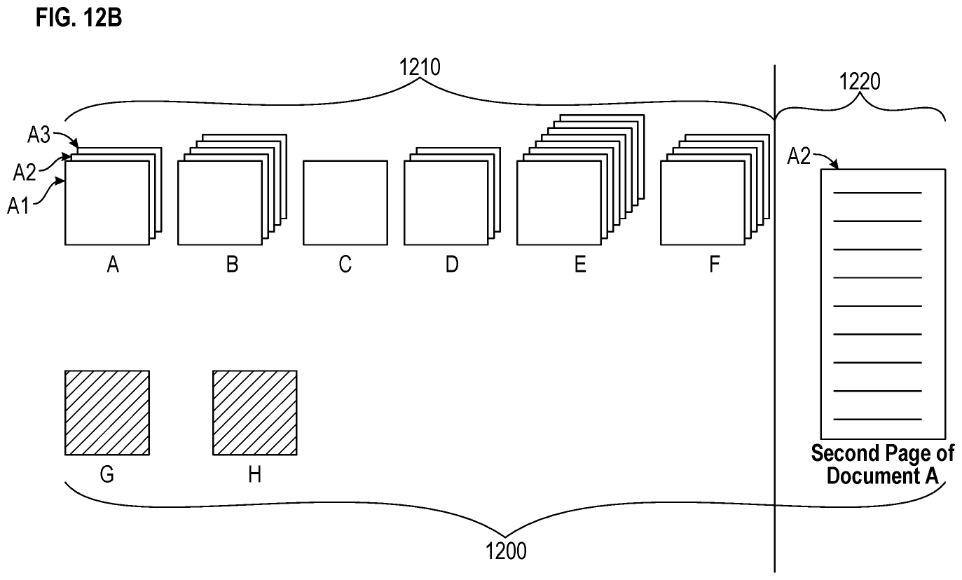

FIG. 12A illustrates a first example of a three-dimensional (3D) display 1210 of a set of documents from a search result. In the example of FIG. 12A, the set of documents may be displayed in a scaled CIF. And, although not shown, in one example, the scaled CIF images may be displayed with meta data information in the image tag.

In FIG. 12A, the search result includes eight (8) documents labeled A, B, C, D, E, F, G and H. In the example of FIG. 12A, the pages shown for each of the eight (8) documents include one or more search text in each page. That is, only pages with one or more search text are shown for each of the eight (8) documents are displayed. For example, in document A, three (3) pages are shown since each of the three (3) pages includes one or more search text. For example, in document B, five (5) pages are shown since each of the five (5) pages includes one or more search text. For example, in document C, one (1) page is shown since only one (1) page includes one or more search text. For example, in document D, three (3) pages are shown since each of the three (3) pages includes one or more search text. For example, in document E, eight (8) pages are shown since each of the eight (8) pages includes one or more search text. For example, in document F, five (5) pages are shown since each of the five (5) pages includes one or more search text. Document G is shown with hashed marks to indicate that each page in the document includes one or more search text. And, document H is shown with hashed marks to indicate that each page in the document includes one or more search text.

In one example, each page with one or more search text of a document includes an active link pointer. As an example, document A includes three active link pointers A1, A2 and A3, one for each of the three (3) pages with one or more search text. When a user clicks on an active link pointer, the page associated with that active link pointer is displayed as a single page. For example, if a user clicks active link pointer A2, the second page with one or more search text of document A is displayed as a single page.

FIG. 12B illustrates the three-dimensional (3D) display 1210 of the search result shown in FIG. 12A with a single page display 1220 on a screen 1200. As shown in FIG. 12B, the single page display 1220 of the second page with one or more search text of document A is adjacent to the three-dimensional (3D) display 1210. In the example, where a user clicks the A2 active link pointer, FIG. 12B illustrates the three-dimensional (3D) display 1210 shown in FIG. 12A with the single page display 1220 showing the second page with one or more search text of document A as a single page.

In an alternative (not shown), the single page display 1220 may replace the three-dimensional (3D) display 1210 of the search result on the screen. In one example, the single page display and the three-dimensional (3D) display are adjacent to each other on a single screen. In another example, the single page display and the three-dimensional (3D) display are displayed on different screens.

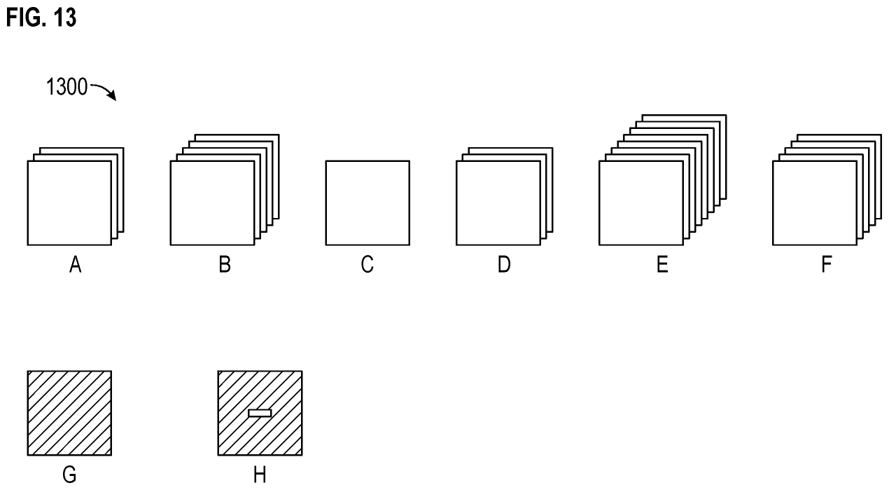

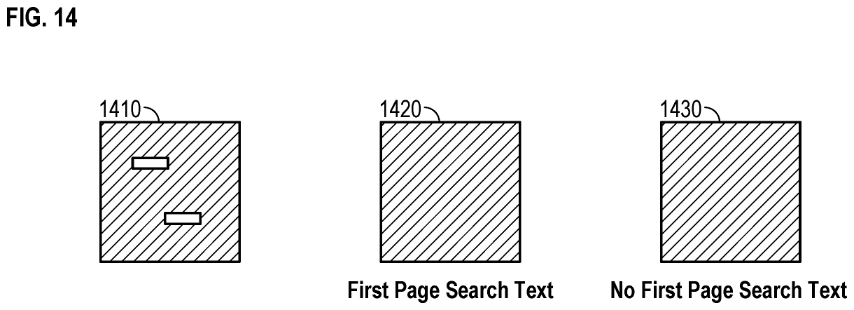

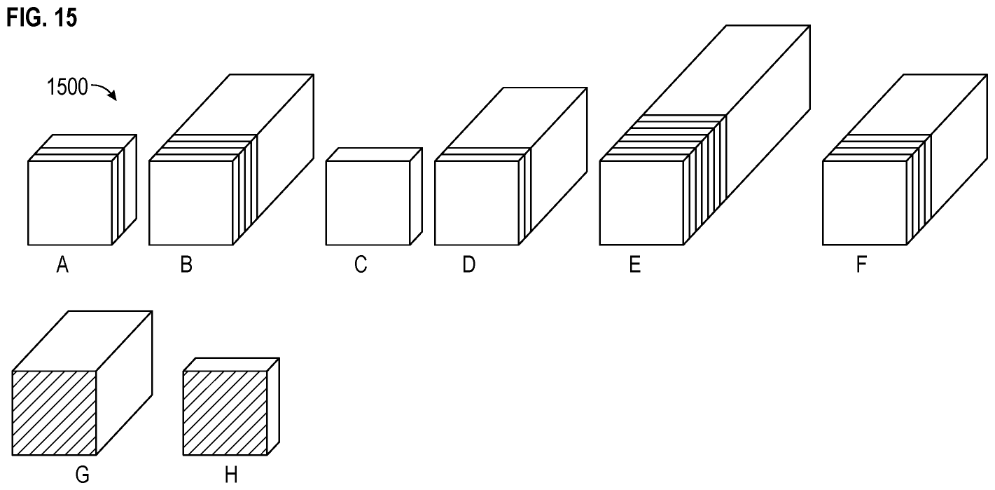

FIG. 13 illustrates a second example of a three-dimensional (3D) display 1300 of a set of documents from a search result. In the example of FIG. 13, the set of documents may be displayed in a scaled CIF. And, although not shown, in one example, the scaled CIF images may be displayed with meta data information in the image tag. In FIG. 13, the search result includes eight (8) documents labeled A, B, C, D, E, F, G and H. In the second example of FIG. 13, the search result may display the eight (8) documents by including the first page of each of the eight (8) documents whether or not a search text is found in the first page.

For example, in document A, three (3) pages (i.e., the first page of document A and two other pages) are shown. In document A, the first page may or may not include a search text while each of the other two pages includes one or more search text. For example, in document B, five (5) pages (i.e., the first page of document A and four other pages) are shown. In document B, the first page may or may not include a search text while each of the other four pages includes one or more search text.

For example, in document C, one (1) page is shown since only one (1) page includes one or more search text. This one page is also the first page of document C. For example, in document D, three (3) pages (i.e., the first page of document A and two other pages) are shown. In document D, the first page may or may not include a search text while each of the other two pages includes one or more search text.

For example, in document E, eight (8) pages (i.e., the first page of document A and seven other pages) are shown. In document E the first page may or may not include a search text while each of the other seven pages includes one or more search text. For example, in document F, five (5) pages (i.e., the first page of document A and four other pages) are shown. In document F the first page may or may not include a search text while each of the other four pages includes one or more search text.

Document G is shown with hashed marks to indicate that each page in the document includes one or more search text. In one example, the first page of document G includes one or more search text. In another example, the first page of document G does not include a search text. And, document H is shown with hashed marks to indicate that each page in the document includes one or more search text. In one example, the first page of document H includes one or more search text. In another example, the first page of document H does not include a search text. In one aspect, a first page indicator may be used to indicate whether the first page of a document includes a search text. As an example, the first page indicator may be a border around the search text found on the first page. One skilled in the art would understand that other types of first page indicators, including but not limited to, highlighting, bolding, etc. around the search text, may be used within the scope and spirit of the present disclosure. In one example, a text, such as “first page search text” or “no first page search test” or any other indication, may be used to indicate that the first page includes or does not include a search text.

FIG. 14 illustrates three examples 1410, 1420, 1430 of indicating whether a first page of a document includes a search text. That is, in one example, a search text indicator is included with the first page. In example 1410, the search text is indicated by a rectangular border around the search text. That is, the rectangular border is a search text indicator. Example 1410 illustrates two locations on the first page where a search text is found. In one example, the same search text appears in the two locations. In another example, the two locations include two different search text. In example, 1420, the text “first page search text” indicates that the first page includes one or more search text. In example, 1430, the text “no first page search text” indicates that the first page does not include a search text. In examples 1420 and 1430, the search text indicator is a text phrase. One skilled in the art would understand that the examples of first page indicators illustrated in FIG. 14 are not exclusive and that other first page indicators may be used within the scope and spirit of the present disclosure.

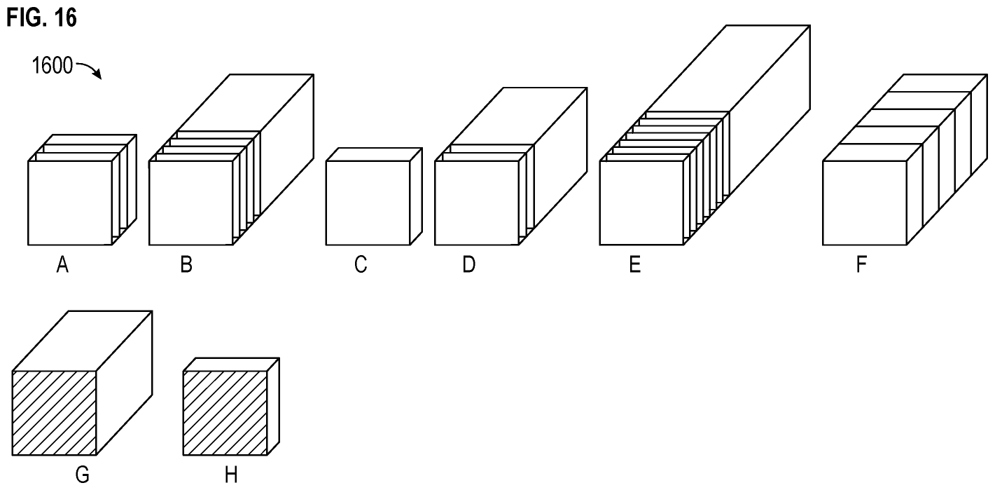

FIG. 15 illustrates an example of a three-dimensional (3D) display 1500 of a set of documents from a search result with indications of relative document length. In one example, document length is the number of pages in the document. In one example, relative document length is an estimate of the number of pages in the document. In the example of FIG. 15, the set of documents may be displayed in a scaled CIF. And, although not shown, in one example, the scaled CIF images may be displayed with meta data information in the image tag. In FIG. 15, the search result includes eight (8) documents labeled A, B, C, D, E, F, G and H.

In the example of FIG. 15, the pages shown for each of the eight (8) documents include one or more search text in each page. In one example, the first page of each of the documents may be shown, and the first page may or may not include a search text. In one example, a user can choose to only include the first page of a document as part of the display if the first page includes at least one search text. In another example, the user can choose to include the first page of a document as part of the display regardless of whether the first page includes a search text or not.

In one example, the relative document length is shown as a three-dimensional display. As illustrated in FIG. 15, the relative document length of document B is greater than the relative document length of document A. That is, document B has more pages than document A. In one example, document A and document D each includes three (3) pages which have one or more search text. As illustrated in FIG. 15, the relative document length of document D is greater than the document length of document A. That is, the display of the documents's relative document lengths indicates that document D has more pages than document A. Additionally, the display of the documents's relative document length with the quantity of pages of each document that includes one or more search text indicates a ratio of pages with search text to relative document length. In the example of documents A and D, the ratio of pages with search text to relative document length of document A is higher than that of document D.

In another example, as illustrated in FIG. 15, the relative document length of document B is substantially the same as the relative document length of document F. And, in this example, both document B and document F have the same quantity of pages (i.e., five pages) with one or more search text.

As shown in FIG. 15, the hashed mark indicates that each page in document G includes one or more search text. And, similarly the hashed mark indicates that each page in document H includes one or more search text. However, the relative document length of document G indicates that it contains more pages than document H. Thus, even though both documents G and H each include 100% of its pages with one or more search text, the display in FIG. 15b indicates that document H is a shorter document (with less pages) than document G (which includes more pages).

FIG. 16 illustrates an example of a three-dimensional (3D) display 1600 of a set of documents from a search result with indications of page location relative to the relative document length. In one example, the location of pages with one or more search text is displayed relative to the relative document length of the document. In the example of FIG. 16, the set of documents may be displayed in a scaled CIF. And, although not shown, in one example, the scaled CIF images may be displayed with meta data information in the image tag.

In FIG. 16, the search result includes eight (8) documents labeled A, B, C, D, E, F, G and H. In the example of FIG. 16, the pages shown for each of the eight (8) documents include one or more search text in each page. As illustrated in FIG. 16, the relative document length of document B is the same as the relative document length of document F. And, in this example, both document B and document F have the same quantity of pages (i.e., five pages) with one or more search text. However, as shown in FIG. 16, the relative locations of the five pages with search text in document B are different than the relative locations of the five pages with search text in document F. In document B, the five pages with search text are more concentrated together, while the five pages with search text in document F are further apart from each other.

In one example, the pages with search text in document E is shown as fairly concentrated with each other. In contrast, the pages with search text in document F is shown as farther apart from each other.

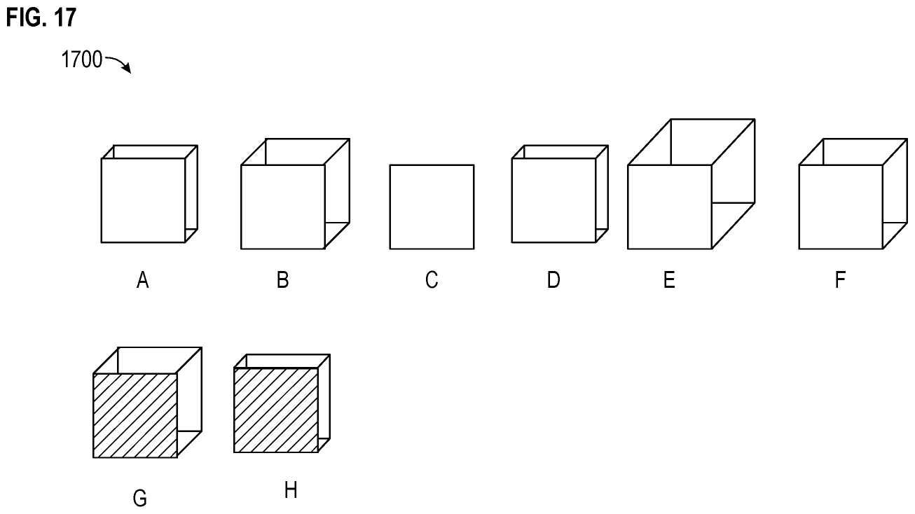

FIG. 17 illustrates an example 1700 of the three-dimensional (3D) display of the search result shown in FIG. 12A without the indication of individual pages. That is, the thickness of each of the documents A through H indicates relative quantity of pages with one or more search text in each of the documents. In the example 1700, the quantity of pages with one or more search text in document G is higher than the quantity of pages with one or more search text in document H. In one example, although the relative quantity of pages with one or more search text in documents B and F appear to be about the same, there is no indication of the location of the pages with one or more search text in document B. And, similarly, there is no indication of the location of the pages with one or more search text in document F in the example 1700 illustrated in FIG. 17.

In all the examples illustrated in FIGS. 1-17, one aspect may include that each of the only pages shown includes all the search text on each of the only pages. In another aspect, each of the only pages shown includes one or more (but not necessarily all) of the search text on each of the only pages.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method for searching and displaying comprising:
inputting at least one search text;
searching a database to generate a search result with at least one document, wherein each of the at least one document includes one or more of the at least one search text;
displaying the search result wherein each of the at least one document is shown in a three-dimensional (3D) display with one or more pages in a scaled common image format (CIF), wherein at least one of the one or more pages includes one or more of the at least one search text.

2. The method of claim 1, wherein a first page of each of the at least one document is shown in the three-dimensional (3D) display.

3. The method of claim 2, wherein the first page includes one of the at least one search text.

4. The method of claim 1, further comprising a search text indicator to one of the at least one document.

5. The method of claim 1, wherein each of the one or more pages includes one or more of the at least one search text.

6. The method of claim 1, wherein the one or more pages of one of the at least one document includes at least one active link pointer.

7. The method of claim 6 further comprising displaying a single page associated with one of the at least one active link pointer on a single page display.

8. The method of claim 7, wherein the single page display is adjacent to the three-dimensional (3D) display.

9. The method of claim 8, wherein the single page display and the three-dimensional (3D) display are adjacent to each other on a single screen.

10. The method of claim 7, wherein the single page display and the three-dimensional (3D) display are displayed on different screens.

11. The method of claim 1, further comprising displaying one or more of the at least one document with its corresponding relative document length.

12. The method of claim 11, further comprising displaying the relative document length as a three-dimensional display.

13. The method of claim 12, further comprising displaying the one or more pages of one of the at least one document with one or more indication of page location relative to the relative document length.

14. An apparatus for searching and displaying, the apparatus comprising a processor and a memory, the memory containing program code executable by the processor for performing the following:
inputting at least one search text;
searching a database to generate a search result with at least one document, wherein each of the at least one document includes one or more of the at least one search text;
displaying the search result wherein each of the at least one document is shown in a three-dimensional (3D) display with one or more pages in a scaled common image format (CIF), wherein at least one of the one or more pages includes one or more of the at least one search text.

15. The apparatus of claim 14, wherein a first page of each of the at least one document is shown in the three-dimensional (3D) display.

16. The apparatus of claim 15, wherein the first page includes one of the at least one search text.

17. The apparatus of claim 14, wherein the memory further comprising program code for including a search text indicator to one of the at least one document.

18. The apparatus of claim 14, wherein each of the one or more pages includes one or more of the at least one search text.

19. The apparatus of claim 14, wherein the one or more pages of one of the at least one document includes at least one active link pointer.

20. The apparatus of claim 19 wherein the memory further comprising program code for displaying a single page associated with one of the at least one active link pointer on a single page display.

21. The apparatus of claim 20, wherein the single page display is adjacent to the three-dimensional (3D) display.

22. The apparatus of claim 8, wherein the single page display and the three-dimensional (3D) display are adjacent to each other on a single screen.

23. The apparatus of claim 20, wherein the single page display and the three-dimensional (3D) display are displayed on different screens.

24. The apparatus of claim 14, wherein the memory further comprising program code for displaying one or more of the at least one document with its corresponding relative document length.

25. The apparatus of claim 24, wherein the memory further comprising program code for displaying the relative document length as a three-dimensional display.

26. The apparatus of claim 25, wherein the memory further comprising program code for displaying the one or more pages of one of the at least one document with one or more indication of page location relative to the relative document length.
